(19) United States
(12) Patent Application Publication
(10) Pub. No.: US 2005/0282517 A1
(43) Pub. Date: Dec. 22, 2005

(54) Radio frequency tuner

(76) Inventor: Nicholas Paul Cowley, Wroughton (GB)

Correspondence Address: ARENT FOX PLLC, 1050 CONNECTICUT AVENUE, N.W., SUITE 400, WASHINGTON, DC, 20036, US

(21) Appl. No.: 11/156,567

(22) Filed: Jun. 21, 2005

(30) Foreign Application Priority Data
Jun. 22, 2004 (GB) 0413945.7

(51) Int. Cl. H04B 1/18; H04B 1/26; H04B 15/00

(52) U.S. Cl. 455/340; 455/315; 455/189.1

(57) ABSTRACT

A radio frequency tuner is provided for selecting for reception a channel from a broadband multiple channel radio frequency signal supplied to its input. The tuner comprises an upconverter which performs frequency upconversion to a frequency range above the highest frequency of the broadband signal. This is followed by an image-reject downconverter which converts the selected channel from the upconverter to near-zero intermediate frequency.

### TECHNICAL FIELD

This submission describes a novel implementation for a broadband tuner, principally intended for digital cable applications though suitable for other distribution media and modulation schemes.

### BACKGROUND

Known receivers use both single conversion and double conversion architecture tuners to interface between a broadband radio frequency (RF) input signal and the digital domain, the choice being dependant upon the application and system requirements. In the case of cable receivers, double conversion is commonly used for analogue and digital video reception and single conversion for digital data reception In both cases, the tuner supplies an output signal at an IF (intermediate frequency) which is then processed by a demodulator section.

More recently, single conversion Near Zero IF (NZIF) techniques have been proposed for reception of, in particular, digital data signals. The basic principal of NZIF techniques is to convert a desired channel to a very low IF, typically placing the desired channel at 0 to F Hz, where F Hz is the channel bandwidth. For example, in the case of US cable channels, the channel bandwidth is typically 6 MHz. The occupied NZIF bandwidth would then be at 0 to 6 MHz. In typical applications, this would actually be shifted slightly in a positive frequency direction, for example to be at 0.25 to 6.25 MHz. The image channel is then the immediately adjacent channel and image cancellation may be achieved by application of an image reject mixer. Such techniques are known and are based on a trigonometric summation of in phase and quadrature signals of the positive and negative frequencies associated with the two sidebands associated with mixing.

A major disadvantage of such an arrangement is that the local oscillator frequency required for converting the desired channel to NIF typically has harmonics which lie within the received band and which may downconvert other channels to the NZIF. For example, a desired channel may occupy a frequency range of 54 to 60 MHz and this is to be converted to 0.25 to 6.25 MHz. The local oscillator frequency may therefore be 60.25 MHz. The local oscillator will have second, third, etc harmonics which in the above case will lie at 60.25×N, where N is an integer greater than 1. The received spectrum potentially occupies all frequencies from 50 to 900 MHz. Therefore, many harmonics of the local oscillator will lie within the received spectrum and many downconvert spurious data to the NZIF.

Such known receivers attempt to overcome this problematic effect by placing a filtering arrangement in front of the NZIF converter. This may comprise of a tracking filter or more commonly an arrangement of selectable contiguous or overlapping fixed bandwidth filters. Such a banded filter is more commonly applied since this is more suitable to integration in an multiple circuit module (MCM) or integrated circuit.

A disadvantage of such an arrangement, however, is that it is difficult to achieve the required suppression of the received harmonic frequencies in an integrated filter. Further, in order to integrate filters capable of suppression at the lower frequencies of the received spectrum, relatively large inductors and/or capacitors are required which are not compatible with current state of the art technologies. Therefore, active filter techniques may be employed. However, known techniques for integrating such filters result in dynamic range, which will leads to the generation of in band spurious products and requires substantial power consumption.

Frequency changers which employ “soft switching”, with the commutating signals supplied to the mixer being substantially in the form of or close to a sine wave, have a better harmonic performance in that harmonics of the switching waveform above the fundamental are of relatively small amplitude. However, the slower switching speed associated with such waveforms results in the generation of more noise because the commutating transistors in the mixer spend more time in the linear part of their characteristic and the resulting relatively high gain increases the level of noise supplied to subsequent stages. In order to produce a tuner with an improved or defined noise figure (NF), it is therefore usual to perform hard switching by supplying a square wave commutating signal to the mixer.

In the above example where the local oscillator frequency is 60.25 MHz, using a square wave as the commutating signal means that the third harmonic of the local oscillator frequency will be at 180.75 MHz and will have an amplitude which is approximately 9 dBc below the amplitude of the fundamental at 60.25 MHz. A channel may be occupied at or adjacent the third harmonic of the commutating signal and may have a signal level as high as 20 dBc above that of the desired channel. Harmonic mixing of such an undesired channel by the third harmonic of the commutating signal may cause substantial interference.

For example, in the case of a spectrum of channels using the 256 QAM standard, the carrier-to-noise ratio required for quasi error free (QEF) reception is at least 30 dBc. The “noise” created by the harmonic mixing mechanism in the example described above must therefore be at least 30 dBc below the carrier level of the desired channel. Thus, the undesired channel must be attenuated by (30+20−9) dBc in order to achieve QEF, giving a minimum requirement of 41 dBc attenuation.

To achieve this level of filtering will require a complex high order filter, such as a fifth order elliptic filter, which will require a number of inductors (either passive or “synthesised”). Such a filter typically has a practical useable bandwidth of about one octave. Thus, a second filter would then be required operating from 100 to 200 MHz, a third from 200 to 400 MHz and a fourth to cover the remainder of the received spectrum.

A further problem with such a known arrangement is that the local oscillator (LO) frequency lies within the received spectrum, typically lying in the immediately adjacent channel. Since the LO frequency is close to the desired channel, which is required to be passed to the mixer stage with minimum effect by the banded filter, then this filter will not provide any suppression to the local oscillator frequency and it may not be possible to meet LO reradiation requirements. Thus, the local oscillator signal may ‘leak’ back onto the distribution network and interfere with other users.

### SUMMARY

According to the invention, there is provided a radio frequency tuner for selecting for reception a channel from a broadband multiple channel radio frequency signal, comprising: an upconverter for performing frequency upconversion to a frequency range above the highest frequency of the broadband signal: and an image-reject downconverter for converting the selected channel from the upconverter to a near-zero intermediate frequency.

The upconverter may be tunable for converting the channel for reception to a substantially fixed intermediate frequency above the highest frequency of the broadband signal and the downconverter may be arranged to perform a substantially fixed frequency downconversion. The upconverter may comprise a commutating signal generator having a frequency range whose lowest frequency is above the highest frequency of the broadband signal. The tuner may comprise a first intermediate frequency filter between the downconverter and the upconverter.

The upconverter may be arranged to perform a substantially fixed frequency upconversion so as to convert the broadband signal to an intermediate frequency band whose lowest frequency is above the highest frequency of the broadband signal and the downconverter may be tunable for converting the channel for reception to the near-zero intermediate frequency. The upconverter may comprise a commutating signal generator having a substantially fixed frequency above the highest frequency of the broadband signal.

The tuner may comprise a second intermediate frequency filter after the downconverter. The second intermediate frequency filter may be a low pass filter.

The tuner may comprise a first automatic gain control arrangement before the upconverter.

The tuner may comprise a second automatic gain control arrangement after the downconverter.

It is thus possible to provide a tuner which reduces or overcomes the disadvantages of the known arrangements. Acceptable reception can be achieved without requiring banded filtering and such a tuner may be embodied with a high degree of integration, for example as an integrated circuit. Upconversion substantially overcomes any problems with harmonic mixing as there is little or no energy at harmonics of a commutating signal frequency used in the upconverter.

### BRIEF DESCRIPTION OF THE DRAWINGS

FIG. 1 is a block circuit diagram of a tuner constituting an embodiment of the invention; and

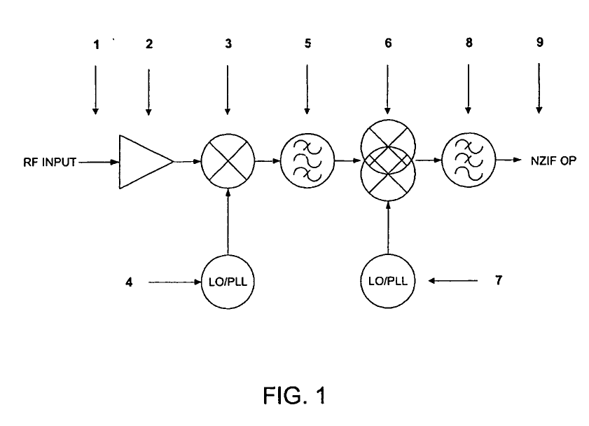

FIG. 2 is a diagram illustrating image reject mixing.

### DETAILED DESCRIPTION

An incoming cable feed 1 is connected to an input low noise amplifier/automatic gain control (LNA/AGC) stage 2 which provides high input signal level gain control. There is no requirement for banded filtering in the input stage 2, although a roofing filter may be provided to provide first and second attenuation below and above the entire received input spectrum. The output of the stage 2 is coupled to a first mixer 3 which provides a block upconversion to a high intermediate frequency (IF) greater than the highest frequency of the received spectrum.

For example, the input spectrum may be 50 to 864 MHz segmented in 6 MHz channels. The high IF may be 1.2 GHz. The required local oscillator 4 frequency range is then 1.253 GHz to 2.061 MHz for centring the desired channel on 1.2 GHz. The first local oscillator frequency always lies outside the received frequency range, hence overcoming reradiation and leakage effects, and harmonics of the local oscillator frequency always lie above the received frequency range, thus eliminating any potential harmonic mixing effects. For example, considering the previous example of the desired channel occupying 50 to 56 MHz, the local oscillator frequency is 1.253 GHz with harmonics at 2.056 GHz, 3.112 GHz etc, all of which lie outside the received spectrum range of 50 to 864 MHz.

A high IF filter 5 is provided after the mixer 3 and has a bandpass response substantially centred on the desired high IF, typically with a bandwidth sufficient to pass several channels. This filter is provided for composite power reduction, for example to relax the intermodulation performance requirements on the following stage, and is not required to provide any image channel cancellation. If the following stage can achieve adequate performance without any filtering, the filter 5 may be omitted. Also, if the mixer 3 performs fixed or substantially fixed upconversion, the filter 5 may be omitted or replaced by band limit filtering.

The signal from the filter 5 is then image reject downconverted by an image-reject mixer 6 to a near-zero IF, for example such that the desired 6 MHz wide channel is centred on 3.25 MHz. In this example with a high IF of 1.2 GHz, a second local oscillator 7 supplies commutating signals to the mixer at a frequency of 1.19675 GHz. The second local oscillator frequency always lies outside the received frequency range, thus overcoming leakage effects, and harmonics of the oscillator also always lie above the received frequency range, so eliminating any potential harmonic mixing effects.

The image reject mixer 6 is followed by a channel filter 8, which has a low pass characteristic and provides the channel filtering (achieved by a SAWF (surface acoustic wave filter) in some conventional architectures). This stage also provides variable gain for operation at low input signal level conditions. Alternatively or additionally, the image reject downconversion may provide all or part of the channel filtering, in which case the channel filter stage 8 provides partial or no channel filtering, but still provides AGC (automatic gain control). The near-zero IF output signal is supplied to a tuner output 9.

The upconversion frequency is controlled by a first phase locked loop (PLL) frequency synthesiser and the downconversion by a second PLL frequency synthesiser forming parts of the oscillators 4 and 7, respectively. This architecture allows for both variable upconversion and fixed or substantially fixed downconversion or vice versa. In the first case, channel selection is achieved at least principally by the upconverter whereas, in the latter, it is achieved by the downconversion.

In some embodiments, the upconverter 3, 4 and/or the downconverter 6, 7 may alternatively or additionally provide variable gain control.

In the above description, for simplicity of description, it has been assumed that the passband of the filter 5, when present, is accurately defined and that the choice of high IF is fixed. In practical systems, however, due to for example manufacturing tolerances, the high IF may vary from the defined value or a variability in the high IF may be required to overcome multiple local oscillator beat issues. In the first instance, an alignment calibration may be carried out to tune the high IF filtering to a desired value (if such filtering is present) or to calibrate the high IF filter and then adjust the tuning pattern to accommodate the variability in the high IF. In the second case, a local oscillator beat pattern can be determined to overcome local oscillator beats, where the beat pattern tunes over a useable bandwidth of the high IF filter.

In embodiments which have no high IF filtering, these issues do not arise. An example of such an embodiment is one which is for use in a terrestrial receiver where the tuner is required to tune over the full frequency range but channel utilisation is low, therefore not requiring the composite power protection offered by the high IF filter 5.

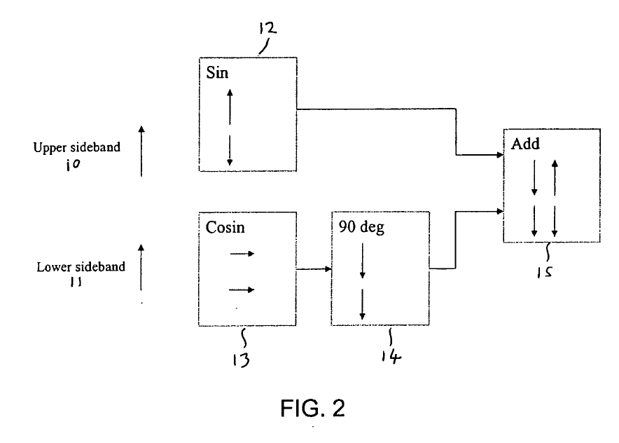

The image reject mixer 6 may be of any suitable type and the principle of operation of a known type of image reject mixer is illustrated in FIG. 2. The phases of the upper and lower sidebands are illustrated at 10 and 11, respectively, and the signal comprising these sidebands is supplied to two mixing circuits which receive commutating signals in phase-quadrature from the local oscillator 7. Following mixing with the commutating signals, the resulting sidebands have positive and negative sines and cosines of the same polarity, as illustrated at 12 and 13. A 90° phase shift shown at 14 is applied to the cosine signals and the phase-shifted cosine signals are added to (or subtracted from) the sine signals at 15. Thus, one sideband is cancelled whereas the other is downconverted.

1. A radio frequency tuner for selecting for reception a channel from a broadband multiple channel radio frequency signal having a highest frequency, said tuner comprising: an upconverter for performing a frequency up-conversion to a frequency range above said highest frequency of said broadband signal; and an image-reject downconverter for converting said selected channel from said upconverter to a near-zero intermediate frequency.

2. A tuner as claimed in claim 1, in which said upconverter is tunable for converting said channel for reception to a substantially fixed intermediate frequency above said highest frequency of said broadband signal and said downconverter is arranged to perform a substantially fixed frequency downconversion.

3. A tuner as claimed in claim 2, in which said upconverter comprises a commutating signal generator having a frequency range whose lowest frequency is above said highest frequency of said broadband signal.

4. A tuner as claimed in claim 2, comprising a first intermediate frequency filter between said downconverter and said upconverter.

5. A tuner as claimed in claim 1, in which said upconverter is arranged to perform a substantially fixed frequency upconversion so as to convert said broadband signal to an intermediate frequency band whose lowest frequency is above said highest frequency of said broadband signal and said downconverter is tunable for converting said channel for reception to said near-zero intermediate frequency.

6. A tuner as claimed in claim 5, in which said upconverter comprises a commutating signal generator having a substantially fixed frequency above said highest frequency of said broadband signal.

7. A tuner as claimed in claim 1, comprising a second intermediate frequency filter after said downconverter.

8. A tuner as claimed in claim 7, in which said second intermediate frequency filter is a low pass filter.

9. A tuner as claimed in claim 1, comprising a first automatic gain control arrangement before said upconverter.

10. A tuner as claimed in claim 1, comprising a second automatic gain control arrangement after said downconverter.
